(19) United States
(12) Patent Application Publication
(10) Pub. No.: US 2023/0087053 A1
(43) Pub. Date: Mar. 23, 2023

(54) APPARATUS AND METHOD FOR WELDING

(71) Applicant: LG ENERGY SOLUTION, LTD., Seoul (KR)

(72) Inventors: Myung An LEE, Daejeon (KR); Duk Hyun RYU, Daejeon (KR)

(73) Assignee: LG ENERGY SOLUTION, LTD., Seoul (KR)

(21) Appl. No.: 17/801,920

(22) PCT Filed: Aug. 5, 2021
(86) PCT No.: PCT/KR2021/010347

§ 371 Date: Aug. 24, 2022

(30) Foreign Application Priority Data
Aug. 24, 2020 (KR) 10-2020-0106094

(51) Int. Cl. B23K 11/25; B23K 11/00; B23K 11/02; B23K 11/11; B23K 11/34; B23K 11/36; B23K 37/00; B23K 37/04; B23K 11/30

(52) U.S. Cl. CPC B23K 11/252; B23K 11/0046; B23K 11/02; B23K 11/115; B23K 11/34; B23K 11/36; B23K 37/003; B23K 37/0443; B23K 11/3063; B23K 2101/38

(57) ABSTRACT

A welding apparatus includes a welding rod; a temperature measuring jig to measure a temperature of the welding rod; and a welding rod cooler to cool the welding rod.

### CROSS CITATION WITH RELATED APPLICATION(S)

This application claims the benefit of Korean Patent Application No. 10-2020-0106094 filed on Aug. 24, 2020 with the Korean Intellectual Property Office, the disclosure of which is incorporated herein by reference in its entirety.

### TECHNICAL FIELD

The present disclosure relates to an apparatus and method for welding, and more particularly, to a welding apparatus and method for manufacturing a secondary battery.

### BACKGROUND ART

As the demands for portable electronic products such as notebooks, video cameras and cellular phones are rapidly increased in these days, and development of electric vehicles, energy storage batteries, robots, satellites, etc. is under active progress, numerous studies are being made on secondary batteries being used as the driving power source.

The electrode assembly mounted in the battery case is a power generating element, having a cathode/separator/anode stack structure, which can be charged and discharged, and the electrode assembly is classified into a jelly-roll type, a stacked type and a stacked/folded type. The jelly-roll type electrode assembly is configured to have a structure in which a long sheet type cathode and a long sheet type anode, to which active materials are applied, are wound in a state where a separator is interposed between the cathode and the anode, the stacked type electrode assembly is configured to have a structure in which a large number of cathodes having a predetermined size and a large number of anodes having a predetermined size are sequentially stacked in a state in which separators are interposed between the cathodes and the anodes, and the stacked/folded type electrode assembly is a combination of the jelly-roll type electrode assembly and the stacked type electrode assembly. Among them, the jelly-roll type electrode assembly has advantages in that manufacturing is easy and an energy density per unit weight is high.

Based on the shape of a battery case, a secondary battery is classified into a cylindrical battery where an electrode assembly is mounted in a cylindrical metal can, a prismatic battery where an electrode assembly is mounted in a prismatic metal can, and a pouch-shaped battery where an electrode assembly is mounted in a pouch-shaped case formed of an aluminum laminate sheet.

When manufacturing such various types of secondary batteries, parts may be combined using a welding apparatus. In a conventional welding apparatus, a welding rod is exposed to the outside and heat generated during welding is not controlled, so the welding rod is prepared in an overheated state before the progress of a next welding. Thus, there is a possibility that the electrode or separator of the welding part may be damaged.

In addition, in the conventional welding apparatus, the upper welding rod is not provided with a temperature measuring mechanism, and resistance fluctuates when the temperature of the welding rod changes, which makes it difficult to apply a uniform current. Even if the temperature is measured, the movement speed of the equipment is fast and the outer diameter of the welding rod is relatively small, which caused a problem that it was difficult to measure the temperature of the upper welding rod.

### DETAILED DESCRIPTION OF THE INVENTION

### Technical Problem

It is an object of the present disclosure to provide a welding apparatus and method that manage a heat of welding rods generated when welding secondary batteries and minimize welding defects.

The objects of the present disclosure are not limited to the aforementioned objects, and other objects which are not described herein should be clearly understood by those skilled in the art from the following detailed description.

### Technical Solution

In order to achieve the above object, according to one embodiment of the present disclosure, there is provided a welding apparatus comprising: a welding rod; a temperature measuring jig configured to measure a temperature of the welding rod; and a welding rod cooler configured to cool the welding rod.

The temperature measuring jig may include a main body; a temperature sensor positioned at an upper end of the main body; and a rotating shaft configured to rotate the main body to position the temperature sensor at a lower end of the welding rod.

The rotating shaft may be located on the main body, and the rotating shaft is configured to rotate the main body in a horizontal direction around the rotating shaft.

The rotating shaft may rotate the main body portion between 0 degrees and 90 degrees.

The welding rod may include an upper welding rod and a lower welding rod, and the temperature sensor may be configured to contact the lower end of the upper welding rod through rotation of the main body to measure the temperature of the upper welding rod.

The welding rod cooler includes a cooling panel; a plurality of cooling holes in the cooling panel; and a blower, the blower being configured to blow cold air flowing through the blower through at least one cooling hole of the plurality of cooling holes to the welding rod.

The cooling panel has a shape curved toward the lower end of the upper welding rod such that the cold air may be blown to the lower end of the upper welding rod.

The plurality of cooling holes may include 5 or fewer cooling holes.

In order to achieve the above object, according to another embodiment of the present disclosure, there is provided a welding method comprising: contacting a temperature measuring jig to a lower end of an upper welding rod to measure the temperature of the lower end of the upper welding rod; moving the temperature measuring jig away from the lower end of the upper welding rod through rotation; moving the upper welding rod toward the lower welding rod to perform a welding process; moving the upper welding rod is away from the lower welding rod after the welding process has been completed; and contacting the temperature measuring jig to the lower end of the upper welding rod through rotation to measure the temperature of the lower end of the upper welding rod again.

The welding method may further include cooling the lower end of the upper welding rod using a welding rod cooler.

### BRIEF DESCRIPTION OF THE DRAWINGS

FIG. 1 is a diagram showing a welding apparatus according to one embodiment of the present disclosure;

FIG. 2 is a diagram showing a state in which the temperature measuring jig section according to one embodiment of the present disclosure enters the lower end of the upper welding rod where welding has been completed, and measures the temperature of the upper welding rod; and

FIG. 3 is a diagram showing a state in which the temperature measurement jig section according to one embodiment of the present disclosure completes the temperature measurement and detaches the lower end part of the upper welding rod, and then the upper welding rod proceeds the welding again.

### DETAILED DESCRIPTION OF THE EMBODIMENTS

It should be appreciated that the exemplary embodiments, which will be described below, are illustratively described to assist in the understanding of the present disclosure, and the present disclosure can be variously modified to be carried out differently from the exemplary embodiments described herein. However, in the description of the present disclosure, the specific descriptions and illustrations of publicly known functions or constituent elements will be omitted when it is determined that the specific descriptions and illustrations may unnecessarily obscure the subject matter of the present disclosure. In addition, in order to help understand the present disclosure, the accompanying drawings are not illustrated based on actual scales, but parts of the constituent elements may be exaggerated in size.

As used herein, terms such as first, second, and the like may be used to describe various components, and the components are not limited by the terms. The terms are used only to discriminate one component from another component.

Further, the terms used herein are used only to describe specific exemplary embodiments, and are not intended to limit the scope of the present disclosure. A singular expression includes a plural expression unless they have definitely opposite meanings in the context. It should be understood that the terms “comprise”, “include”, and “have” as used herein are intended to designate the presence of stated features, numbers, steps, movements, constitutional elements, parts or combinations thereof, but it should be understood that they do not preclude a possibility of existence or addition of one or more other features, numbers, steps, movements, constitutional elements, parts or combinations thereof.

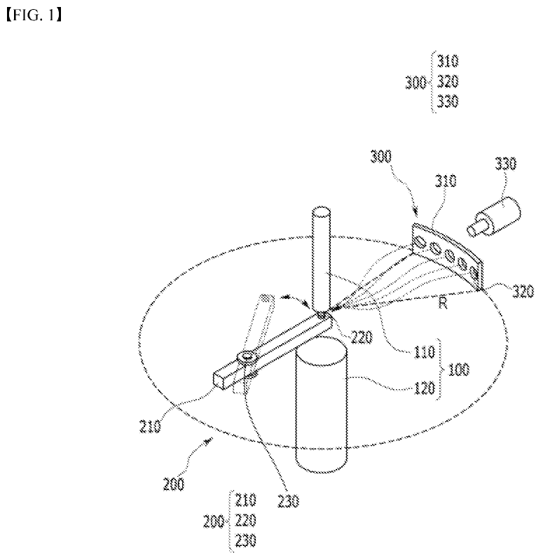

Below, the structure of a welding apparatus according to one embodiment of the present disclosure will be described with reference to FIG. 1.

FIG. 1 is a diagram showing a welding apparatus according to one embodiment of the present disclosure.

Referring to FIG. 1, the welding apparatus according to the present embodiment includes a welding rod 100, a temperature measuring jig section that measures the temperature of the welding rod 100, and a welding rod cooler section 300 that cools the welding rod 100. The welding rod 100 includes an upper welding rod 110 and a lower welding rod 120, and a welding process can be performed between the upper welding rod 110 and the lower welding rod 120. The welding rod 100 described later may refer to the upper welding rod 110.

The temperature measuring jig section 200 may include a main body portion 210 formed in a bar shape, a temperature sensor 220 that is positioned at the upper end of the main body portion 210, and a rotating shaft portion 230 that rotates the main body portion 210 to position the temperature sensor 220 at the lower end of the welding rod 100. The temperature of the lower end of the welding rod 100 can be measured through the temperature sensor 220 positioned in the temperature measuring jig section 200.

The conventional welding apparatus was not provided with a temperature sensor, so there was a problem that resistance fluctuates when the temperature of the welding rod changes, which makes it difficult to apply a uniform current to the welding rod. Further, even if the temperature sensor is provided, there was a problem that the outer diameter of the upper welding rod is relatively smaller than that of the lower welding rod, and thus it is difficult to accurately measure the temperature of the lower end part of the upper welding rod. Further, the production speed can be increased by using a plurality of welding rods in a general battery production process, but it was necessary to maintain a uniform temperature of the plurality of welding rods and realize uniform welding quality for each welding section.

On the other hand, according to the present embodiment, the temperature of the lower end part of the welding rod 100 is measured by using the temperature sensor 220 positioned at the upper end of the main body 210, and the temperature of the welding rod is adjusted through the measured temperature, thereby capable of ensuring the uniformity of welding quality welding.

According to the present embodiment, the welding rod cooler section 300 includes a cooling panel 310 and a plurality of cooling holes 320 formed in the cooling panel 310, and the cooling holes 320 may be connected to a blower 330, and the cold air flowing-in through the blower 330 may pass through the cooling holes 320 to be blown to the lower end of the welding rod 100.

In the conventional welding apparatus, a separate cooling means for the welding rod did not exist, and an air conditioner type blower was used, but in the case of an air conditioner type blower, there was a problem in that it was difficult to intensively cool at a desired position. Further, since the welding cycle is repeated rapidly in the battery production process, rapid cooling of the welding rod was sometimes required. According to this embodiment, the welding cycle can be proceeded at a speed at which one cycle circulates within one second.

In this regard, according to the present embodiment, a plurality of cooling holes 320 formed in the cooling panel 310 formed so as to have a curvature toward the lower end of the welding rod 100 are connected to the blower 330, and the cold air flowing-in through the blower 330 passes through the cooling hole 320 formed toward the lower end of the welding rod 100 and is intensively blown to the lower end part of the welding rod where heat generation is relatively intense, thereby rapidly cooling the welding rod and improving the welding efficiency.

Below, the operation of the temperature measuring jig section and the welding rod cooler section according to one embodiment of the present disclosure will be described with reference to FIGS. 1 to 3.

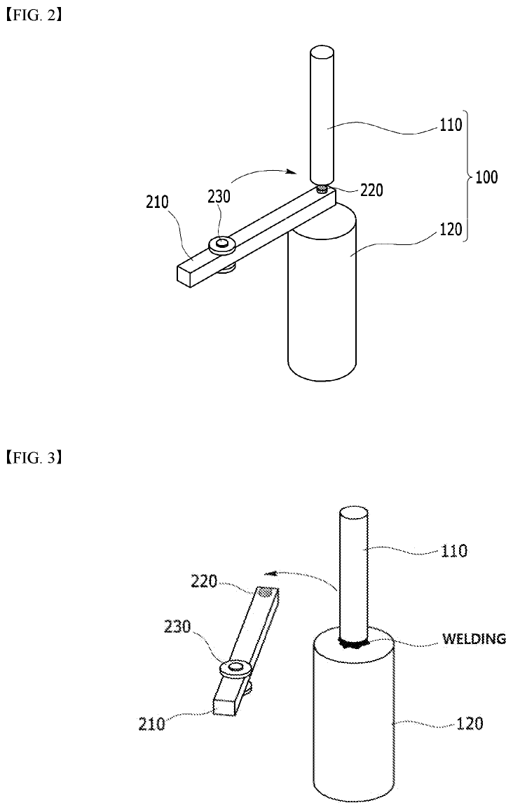

FIG. 2 is a diagram showing a state in which the temperature measuring jig section according to one embodiment of the present disclosure enters the lower end of the upper welding rod where welding has been completed, and measures the temperature of the upper welding rod. FIG. 3 is a diagram showing a state in which the temperature measurement jig section according to one embodiment of the present disclosure completes the temperature measurement and detaches the lower end part of the upper welding rod, and then the upper welding rod proceeds the welding again.

Referring to FIGS. 2 and 3, in the temperature measuring jig section 200 according to the present embodiment, the rotating shaft portion 230 is formed on the main body portion 210 and can rotate the main body portion 210 in a horizontal direction around the rotating shaft portion 230. The rotating shaft portion 230 may be fixed to a specific position outside the welding apparatus. At this time, the rotating shaft portion 230 can rotate the main body portion 210 between 0 degrees and 90 degrees. When the rotation of the main body portion 210 exceeds 90 degrees, the main body portion 210, which was spaced apart, requires a relatively large amount of power to return to the lower end part of the upper welding rod for temperature measurement, and therefore, the rotation angle of the main body portion 210 is preferably formed within 90 degrees. Further, when temperature measurement is not performed, it is preferable that the rotation angle of the main body portion 210 is rotated at an angle that can be spaced apart from the welding rod 100 at least to thereby maintain an angle at which the main body portion 210 and the temperature measuring jig section 200 are positioned so as to be spaced apart from each other.

A temperature sensor 220 is mounted on the upper surface of the end of the main body portion 210, and the temperature sensor 220 can come into close contact with the lower end part of the welding rod 100 through rotation to measure the temperature of the welding rod 100.

Therefore, when the welding rod 100 performs welding, the end part of the main body portion 210 around the rotating shaft 230 is positioned at a position spaced apart from the lower end part of the welding rod 100. When the upper welding rod 110 is spaced apart from the lower welding rod 120 after welding has been completed, as shown in FIG. 2, the temperature sensor 220 mounted on the end part of the main body portion may be positioned at the lower end part of the upper welding rod 110 by rotating the main body portion 210 around the rotating shaft 230. Further, after the temperature measurement has been completed through the temperature sensor 220, as shown in FIG. 3, the main body portion 210 is rotated in the outer direction of the welding rod around the rotating shaft portion 230 again, so that the main body portion 210 is positioned at a position spaced apart from the welding rod 100. The above-described rotating step of the main body portion 210 may be repeatedly performed in proportion to the number of repeated welding progress.

At this time, the temperature sensor 220 may be positioned so as to be in contact with the lower end part of the upper welding rod 110. Therefore, the rotating shaft part 230 and the main body portion 210 may be positioned on the same horizontal plane as the portion where the lower end part of the upper welding rod 110 is positioned when welding is not performed.

According to the present embodiment, the rotation of the main body portion 210 via the rotation shaft portion 230 rotates in a direction perpendicular to the longitudinal direction of the welding rod 100, so that the interference between the welding rod 100 and the temperature measuring jig section 200 can be minimized.

The cooling panel 310 constituting the welding rod cooler section 300 may be formed in a shape curved toward the lower end part of the welding rod 100. The cooling panel 310 may be formed so as to have a constant radius of curvature R. At this time, the radius of curvature (R) can be adjusted according to the type of the welding rod to adjust the curved angle of the cooling panel 310. Through this, the curved angle of the cooling panel 310 can be adjusted to suit the types of welding rods having various sizes and shapes, so that the cool air guided from the cooling hole 320 formed on the curved surface of the cooling panel 310 may be intensively blown to the portion where heat generation is intense.

According to the present embodiment, the plurality of cooling holes 320 may be formed into 5 or less. When the number of cooling holes 320 formed in the cooling panel 310 exceeds 5, interference between cold airs blown through the cooling hole 320 occurs, and cooling of the lower end part of the welding rod 100 cannot be performed properly. Thus, the number of the cooling holes 320 is preferably formed to be 5 or less.

Below, a welding method according to one embodiment of the present disclosure will be described with reference to FIGS. 1 to 3.

Referring to FIGS. 2 and 3, in the welding method according to this embodiment, a step in which a temperature measuring jig section 200 comes into close contact with the lower end of an upper welding rod 110 to measure the temperature of the lower end of the upper welding rod 110, a step in which the temperature measuring jig section 200 is detached from the lower end of the upper welding rod 110 through rotation, a step in which the upper welding rod 110 is moved in a direction in which the lower welding rod 120 is positioned to perform a welding process, a step in which the upper welding rod 110 is returned to the upper side after the welding process has been completed; and a step in which the temperature measuring jig section 200 comes into close contact with the lower end of the upper welding rod 110 through rotation to measure the temperature of the lower end of the upper welding rod 110 again, can be sequentially carried out.

As described above, the temperature sensor 220 is periodically positioned at the lower end part of the upper welding rod 110 via the repeated rotational movement of the main body portion 210, whereby the temperature at the lower end part of the upper welding rod, which can change between repeated welding processes, can be repeatedly measured, so that the temperature of the welding rod can be controlled more precisely, and the welding quality can be improved.

According to the present embodiment, in each step of the above-described welding method, a step in which the welding rod cooler section 300 cools the lower end part of the upper welding rod 110 can be further included. Therefore, the welding process cycle is repeatedly performed, and thus the temperature measurement associated therewith s periodically performed. At the same time, the lower end part of the upper welding rod 110 is continuously cooled through the welding rod cooler section 300, thereby improving overall welding quality.

Although the invention has been shown and described with reference to preferred embodiments, the scope of the present disclosure is not limited thereto, and numerous other modifications and embodiments can be devised by those skilled in the art, without deviating from the spirit and scope of the principles of the invention described in the appended claims. Further, these modified embodiments should not be understood individually from the technical spirit or perspective of the present disclosure.

[Description of Reference Numerals]

| | |
|---|---|
| 100: welding rod | 110: upper welding rod (welding rod) |
| 120: lower welding rod | 200: temperature measuring jig section |
| 210: main body portion | 220: temperature sensor |
| 230: rotating shaft portion | 300: welding rod cooler section |
| 310: cooling panel | 320: cooling hole |
| 330: blower | |

### INDUSTRIAL APPLICABILITY

In the welding apparatus and method according to one embodiment of the present invention, a temperature sensor can be attached to a portion in contact with the upper welding rod to thereby measure the temperature of the upper welding rod, and the welding rod cooler section can be formed in a fan shape to intensively cool the lower end of the upper welding rod, thereby efficiently controlling the temperature of the welding rod.

The effects of the present disclosure are not limited to the effects mentioned above and additional other effects not described above will be clearly understood from the description of the appended claims by those skilled in the art.

1. A welding apparatus comprising:
a welding rod;
a temperature measuring jig configured to measure a temperature of the welding rod; and
a welding rod cooler configured to cool the welding rod.

2. The welding apparatus of claim 1, wherein the temperature measuring jig includes:
a main body;
a temperature sensor positioned at an upper end of the main body; and
a rotating shaft configured to rotate the main body to position the temperature sensor at a lower end of the welding rod.

3. The welding apparatus of claim 2, wherein the rotating shaft is located on the main body portion, and the rotating shaft is configured to rotate the main body portion in a horizontal direction around the rotating shaft.

4. The welding apparatus of claim 3, wherein the rotating shaft is configured to rotate the main body portion between 0 degrees and 90 degrees.

5. The welding apparatus of claim 2, wherein the welding rod includes an upper welding rod and a lower welding rod, and
wherein the temperature sensor is configured to contact a lower end of the upper welding rod through rotation of the main body to measure the temperature of the upper welding rod.

6. The welding apparatus of claim 2, wherein the welding rod cooler includes:
a cooling panel;
a plurality of cooling holes in the cooling panel; and
a blower, the blower being configured to blow cold air flowing through the blower through at least one cooling hole of the plurality of cooling holes to the welding rod.

7. The welding apparatus of claim 6, wherein the welding rod includes an upper welding rod and a lower welding rod, and
wherein the cooling panel has a shape curved toward a lower end of the upper welding such that the cold air is blown to the lower end of the upper welding rod.

8. The welding apparatus of claim 6, wherein the plurality of cooling holes include 5 or fewer cooling holes.

9. A welding method comprising:
contacting a temperature measuring jig to a lower end of an upper welding rod to measure a temperature of the lower end of the upper welding rod;
moving the temperature measuring jig away from the lower end of the upper welding rod through rotation;
moving the upper welding rod in a direction toward a lower welding rod to perform a welding process;
moving the upper welding rod away from the lower welding rod after the welding process is completed; and
contacting the temperature measuring jig to the lower end of the upper welding rod through rotation to measure the temperature of the lower end of the upper welding rod again.

10. The welding method of claim 9, further comprising cooling the lower end of the upper welding rod using a welding rod cooler.

11. A welding method using the welding jig of claim 1, the welding rod including an upper welding rod and a lower welding rod, the welding method comprising:
contacting the temperature measuring jig to a lower end of the upper welding rod to measure the temperature of the lower end of the upper welding rod;
moving the temperature measuring jig away from the lower end of the upper welding rod through rotation;
moving the upper welding rod in a direction toward the lower welding rod to perform a welding process;
moving the upper welding rod away from the lower welding rod after the welding process is completed; and
contacting the temperature measuring jig to the lower end of the upper welding rod through rotation to measure the temperature of the lower end of the upper welding rod again.

12. The welding method of claim 11, further comprising cooling the lower end of the upper welding rod using a welding rod cooler.
